(19) United States
(12) Patent Application Publication
(10) Pub. No.: US 2023/0262071 A1
(43) Pub. Date: Aug. 17, 2023

(54) METHOD FOR MONITORING DATA TRAFFIC BETWEEN CONTROL DEVICES OF A MOTOR VEHICLE AND VEHICLE EQUIPPED ACCORDINGLY

(71) Applicants: AUDI AG, Ingolstadt (DE); TTTECH AUTO AG, Wien (AT)

(72) Inventors: Alexandru STIRECIU, Bukarest (RO); Costel PATRASCU, Bukarest (RO); Karsten SCHMIDT, Ingolstadt (DE); Bernhard STANGL, Wien (AT); Jose Antonio MUNOZ CEPILLO, Barcelona (ES)

(73) Assignees: AUDI AG, Ingolstadt (DE); TTTECH AUTO AG, Wien (AT)

(21) Appl. No.: 18/012,088

(22) PCT Filed: Oct. 20, 2021
(86) PCT No.: PCT/EP2021/079303

§ 371 Date: Dec. 21, 2022

(30) Foreign Application Priority Data
Oct. 28, 2020 (DE) 10 2020 128 285.0

(51) Int. Cl. H04L 9/40; H04L 12/40

(52) U.S. Cl. CPC H04L 63/1408; H04L 63/1441; H04L 12/40; H04L 2012/40273; H04L 2012/40215

(57) ABSTRACT

A method monitors data traffic between control devices of a motor vehicle. In the method, at least one data pattern of a packet type and/or data content to be monitored and/or detected is stored in an associative memory such that in response to input data, which contains the respective data pattern, an associated hit signal is generated by the associative memory, and a network processor reads out detection data from received data packets in predetermined monitoring positions and forms input data for the associative memory therefrom. The network processor examines whether a hit signal results by inputting the input data into the associative memory, and a microprocessor recognizes based on transmission schedule data, which describes an intended transmission scheme of the control devices, by a predetermined comparison routine whether the hit signals deviate from the transmission scheme.

### CROSS REFERENCE TO RELATED APPLICATIONS

This application is a U.S. national stage of International Application No. PCT/EP2021/079303, filed Oct. 22, 2021. The International Application claims the priority benefit of German Application No. 10 2020 128 285.0 filed on Oct. 28, 2020. Both the International Application and the German Application are incorporated by reference herein in their entireties.

### BACKGROUND

The invention relates to a method for monitoring data traffic between control devices of a motor vehicle as well as to a correspondingly equipped motor vehicle. The monitoring occurs in a switch device, which transfers data packets between network branches of a data network. Without significant delay or latency occurring in forwarding herein, the data packets or at least some thereof are to be examined to the effect if it is predetermined, undesired data traffic, as it can for example be a constituent of a hacker attack or be caused by a manipulated or defective control device of the motor vehicle.

Because such control devices can be coupled to each other via a data network or data net in a motor vehicle to exchange data packets, whereby a vehicle functionality including multiple control devices can for example be realized. An example for such a data network is an Ethernet network. Network branches of such a data network can be interconnected via a switch device (a short term is also “switch” or data switch). Thereto, each network branch can be connected to a respective port of the switch device. Such a port can be a physical connection for a network cable of the network branch as well as a circuit for transmitting and receiving data packets. If a data packet arrives at such a port from the network branch connected thereto, thus, it is ascertained, into which other network branch or into which multiple other network branches the data packet has to be forwarded. Then, the data packet is forwarded or transmitted to the corresponding target port by means of a circuit, which is here referred to as switch circuit, within the switch device. By such switched forwarding of data packets, network branches can be kept logically separated from each other, whereby a firewall functionality can also be realized.

In order to ascertain, where a received data packet has to be forwarded to, thus, at which target port it has to be passed within the switch circuit, a so-called associative memory can be used. Another designation for such an associative memory is also CAM filter (CAM—content addressable memory), such as for example the TCAM (ternary content addressable memory). By means of an associative memory, the so-called switching or routing in said switch circuit can be adjusted. However, in an associative memory, only a limited number of bits or bytes can be input from the respective received data packet as input data to obtain target port data, which describes the at least one target port to be used.

In an analysis of the data traffic of control devices for detecting a manipulation in one of the control devices and/or for detecting an unauthorized device additionally connected to the data network, an expensive analysis of the data packets transferred in the network can be required. However, this is not allowed to result in the fact that an additional latency or waiting time in transferring the data packets occurs because the corresponding functionality depending on the data packet in the motor vehicle can be impaired otherwise, for example the control of a reversing camera. On the other hand, decoupling or copying data packets for a detailed analysis is associated with such a large data volume that the computing capacity required hereto cannot be provided in a motor vehicle with reasonable expenditure.

From U.S. Pat. No. 8,582,428 B1, it is known that data packets of a certain packet type can be counted by means of counters in a router by means of an associative memory, TCAM. In addition, the data packets can be provided with a timestamp to perform an analysis of the data traffic. Timestamps are also used to measure an age of a communication link.

From WO 2019/116973 A1, it is known that unauthorized data traffic is recognized in a motor vehicle by the fact that a control device generates more data per second than it is originally intended. A manipulation of a control device, which only carries few data packets for generating a damage in the motor vehicle, cannot be recognized thereby.

From WO 2006/069041 A2 and US 2007/022474 A1, it is known that in a firewall, data packets are always deleted if the number of data packets of a certain type from a certain sender per given time unit is above a threshold value, With this approach, only a so-called denial of service attack can be blocked, which is based on the plentiful generation of data packets.

From US 2020/304532 A1, it is known to analyze data traffic in a motor vehicle by means of a TCAM associative memory to detect unusually high data traffic from a device. In order that a microprocessor is not overloaded in analyzing unusual data packets, all of the data packets are prefiltered by means of a first rule and only such data packets, which are unusual according to the first rule, are forwarded to the microprocessor for applying the second rule.

From US 2017/118 041 A1, a firewall computer is known, which filters data packets by means of multiple distributed TCAM associative memories and therein passes certain data packets to a CPU. In context of the firewall rules, ACL, it can be counted in the firewall computer, which rule has been applied how many times.

### SUMMARY

The invention is based on recognizing unscheduled data traffic of a control device or an additionally connected device in a motor vehicle.

A method for monitoring data traffic between control devices of a motor vehicle is provided, wherein at least one data pattern of a packet type and/or data content to be monitored and/or detected is stored in an associative memory (e.g. TCAM), such that an associated hit signal is generated by the associative memory in response to input data containing the respective data pattern. A network processor correspondingly reads out detection data from received data packets in predetermined monitoring positions and forms input data for the associative memory therefrom. The network processor examines whether a hit signal results by inputting the input data into the associative memory, and based on transmission schedule data describing an intended transmission scheme of the control devices, a microprocessor recognizes whether the hit signals deviate from the transmission scheme by a predetermined comparison routine. Then, a defense routine can be started. A data pattern can be a bit pattern or byte pattern.

Hereto, a method is described to monitor data traffic between control devices of a motor vehicle. The method assumes that the control devices are connected via a data network, in which a switch device interconnects physical ports for receiving and for transmitting data packets via an internal switch circuit or data switch. In the method, a target port data is ascertained to a respective data packet, which has been received via one of the ports, by a network processor by an associative memory. At least one port is selected as the target port from the (overall present) ports depending on the ascertained target port data, and the received data packet or at least a part thereof is passed to the at least one target port by the switch circuit.

Thus, in a manner known per se, the switch device internally comprises the switch circuit for optionally transferring a received data packet from a port to at least one target port to thus transfer (to switch or route) the data packet between network branches. Hereto, each port can comprise a transceiver circuit to receive and/or transmit a data packet. The associative memory mentioned here can be implemented or provided as a CAM (content addressable memory), in particular as a TCAM (ternary content addressable memory). The target port data results from the control device or devices respectively connected to the port in a manner known per se.

In an aspect of the invention, at least one data pattern of a packet type and/or data content to be monitored and/or detected is stored in the associative memory such that the associative memory generates an associated hit signal in response to such input data containing the respective data pattern. The network processor correspondingly reads out data for ascertaining the at least one target port from the respective received data packet, and additionally reads out detection data in predetermined monitoring positions of the data packet (thus in preset bit positions or byte positions) and merges it to further input data for the associative memory. The network processor then examines whether a hit signal results by inputting this input data into the associative memory. Thus, the associative memory is also used to detect data packets of a preset packet type and/or with a preset data content. Herein, by presetting the monitoring positions (thus bit positions or byte positions), it is determined where in the data packet, thus at which location, bits or bytes are to be read out from the data packet as detection data, from which input data for the associative memory is formed. This input data for the associative memory then serves for finding a target port, and also generates a hit signal by the associative memory, which indicates that the associated data pattern has been recognized. Such a hit signal can for example include a flag, which signals that the corresponding data pattern has been recognized in the input data by the associative memory.

In addition, at least one counter is provided, by the respective counter value of which it is indicated how often a hit signal was generated to at least one predetermined data pattern. The respective counter value and the respectively last data packet, by which the counter value was lastly increased, are provided as analysis data in a readout memory and a microprocessor reads out this current analysis data via a data interface. Here, it is thus allowed to count how often at least one predetermined data pattern has been recognized or detected, which results from monitoring data of certain monitoring positions of a data packet. A counter can also be used for multiple different hit signals, thus, for multiple different data patterns, in that a single counter is coupled to multiple entries of the associative memory. In the analysis data, the information is present, which data packet has lastly increased the counter value, wherein the counter value is additionally also stored in the analysis data in the readout memory. This can then be actively read out by a microprocessor as needed. The analysis data in the readout memory can thus be updated with each counter change. A separate memory location can be provided for each counter or a common memory location can be provided for the analysis data of multiple or all of the counters.

In a motor vehicle, at least a part of the data traffic is generated by control devices, which follow a fixedly programmed transmission scheme. Only a previously known portion of the data traffic is dynamic, for example data traffic of a control device for entertainment electronics. However, the portion can also be zero. Based on transmission schedule data describing the intended transmission scheme of the control devices, the microprocessor now recognizes a predetermined comparison routine when the analysis data deviates from the transmission scheme, and it initiates a predetermined defense routine in this case.

Here, an aspect of the invention is thus based on the realization that in an unmanipulated (or self-driving) motor vehicle, if none of the control devices deviates from its transmission scheme and an additional device either is not connected to the data network or does not generate additional data traffic, then, only such analysis data may result, which corresponds to the transmission scheme according to the comparison routine, as it is described by the transmission schedule data, which e.g. the manufacturer of the motor vehicle can specify. The comparison routine can request an exact coincidence with this transmission schedule data or a tolerance for the counter values and/or data contents of the final analysis data can be allowed. In particular, the described method can be applied to Ethernet data packets. An Ethernet as a data network is based on packet-oriented data traffic such that (different from a time slot-oriented data network) transmitting points of time and/or data amounts can vary in the data traffic since reserved time slots are not provided.

By the counter value, it can be recognized whether the number of the data packets exceeds a threshold value for a certain data pattern, independently of the exact transmitting point of time. Since the associated data packet, which has triggered exceedance of the threshold value, is additionally also contained in the final analysis data, a conclusion about the transmitter can be drawn, thus a manipulated or defective control device can be recognized, or it can be recognized that a sender address is used, which does not belong to a delivery-side control device of the motor vehicle, but to a device additionally connected to the data network. As the defense routine or defense measure, a restriction of the functionality in the motor vehicle can for example be effected, e.g. a reduction of a functional extent or turning off the functionality, such as a media reproduction and/or a telephony function and/or an Internet connection. According to TCAM entry or data pattern, for which it is recognized that a deviation from the transmission scheme has occurred, a different functionality of the motor vehicle can be restricted or switched off.

The respective counter and/or the associative memory (TCAM) can each be a part of the network processor or the respective counter and/or the associative memory can be provided outside of the network processor.

The invention also includes aspects, by which additional advantages arise.

An aspect includes that for each counter a timestamp of the respectively last increase of the counter value is also kept stored in addition to the counter value and provided as a part of the analysis data in the readout memory. Thus, the analysis data in the readout memory includes the counter value, the timestamp thereof and the associated, lastly received data packet. Thus, the counter value used here signals when the data packet contained in the analysis data has arrived and has triggered the hit signal. It has turned out that this allows a particularly sensitive error and manipulation recognition in context of transmission schemes of control devices. Thus, the microprocessor, which examines the analysis data by the comparison routine, can additionally also receive a respective activity signal of at least one vehicle component and/or of a control device and then examine based on the timestamp when the data packet has been transmitted due to this signaled activity of the vehicle component and/or the control device and thus is recognized as being outside of the transmission scheme, but is accepted as a data packet triggered by this activity and thereby is nevertheless classified as reliable such that the defense routine does not have to be initiated. The activity signal can be received e.g. via a CAN bus. Herein, it can in particular be important that the microprocessor cannot be overloaded hereby, since it can be decided in the microprocessor itself if the data packet is actually retrieved from the readout memory/at the data interface or if it is to be overwritten by the next data packet because the microprocessor currently does not have free resources for the real-time processing. Herein, the overview remains in the microprocessor since to each data packet, the serial number (counter) and/or the time stamp thereof are available. Thus, the application subject matter provides a monitoring tool for a microprocessor, which can prevent an overload of the microprocessor and still provides a detailed insight in “suspicious” data packet or data packets selected by the associative memory (the data packet itself is also provided at the data interface). Thus, the data packets are provided only at a data interface in order that the microprocessor always can decide itself if it retrieves a data packet when corresponding computing capacity is available. If the microprocessor then receives a data packet at the data interface, it is signaled to it by the counter value and the timestamp, which data packet is present and/or how old the data packet is.

An aspect includes that at least one counter respectively counts the hit signals for at least two data patterns. That is, the hit signals for at least two different data patterns are respectively merged in at least one counter. Thus, the counter is always incremented if anyone of the two data patterns is recognized by the associative memory. Hereby, the advantage arises that such a manipulation can also be recognized, in which it is attempted to divide manipulated data traffic to multiple different packet types, for example using two different sender addresses and/or MAC addresses (MAC—medium access control).

An aspect includes that the respective counter value of the at least one counter is reset by the network processor and/or the microprocessor when a predetermined reset condition is satisfied. In other words, not the absolute number of all of the data packets of a certain data pattern since the beginning of the operation of the motor vehicle is counted, but counting intervals can be set. A possible counting interval is a time unit, that is the reset condition can provide that the respective counter is reset after elapse of a predetermined period of time, for example after one second or after ten seconds or one minute. An own reset condition can be provided for each data pattern. Another reset condition can be in that depending on a signal, a shifting operation or an activity in a component of the motor vehicle, for example in a reversing camera or in a media player, a counter for such a data pattern, which is associated with this component, is reset.

An aspect includes that multiple position datasets are provided for different monitoring positions (thus datasets with respective indications to bit positions and/or byte positions) and a packet characteristic of the respective data packet is ascertained by the network processor based on the data packet (header data and/or payload data), and depending on the packet characteristic, one of the position datasets is selected such that alternating monitoring positions arise, and the detection data is read out in the monitoring positions indicated by the selected position dataset. In other words, it can be determined for different packet characteristics, which bits or bytes, thus in which positions within the data packet (monitoring positions), the data content for the detection data is read out to form the input data for the associative memory therefrom. Hereby, the advantage arises that different monitoring positions can be examined depending on the packet characteristic. Which packet characteristic a data packet has, can for example be recognized on the header data and/or payload data thereof. In this context, the following aspect is advantageous.

The aspect includes that the packet characteristic indicates a protocol type (TCP or UDP) and/or packet types (first packet of a communication, subsequent packet) and/or data contents (transmitter address, receiver address). As the protocol type, it can for example be distinguished between TCP (transport control protocol) and UDP (user datagram protocol) to just exemplarily name two possible protocols for the data traffic in a motor vehicle. As the packet type, it can for example be distinguished if it is a first packet of a communication or a subsequent packet of the communication. For example, the so-called SYN flag can here be evaluated. A data content in the form for example of the transmitter address and/or receiver address can also be advantageously used for forming the input data for the associative memory. Hereon, a non-registered transmitter address can for example be detected.

An aspect includes that the monitoring positions describe disjunct data fields of the data packet. Thus, reading out the detection data for forming the input data for the associative memory does not have to include a consecutive sequence of bits or bytes from the data packet, but by setting disjunct data fields, such bits or bytes can also be read out, between which further bits or bytes are located, which do not become part of the detection data. Hereby, one is more flexible in the analysis of the data packets.

An aspect includes that forming the input data from the detection data of the data packet includes that the detection data is rearranged by a shift operation and/or combined by at least one combination rule. Hereby, preprocessing can occur in that a shift operation and/or a combination rule are applied. A combination rule can for example include a logical operation, such as for example AND (logical AND) or OR (logical OR). Thus, bits or bytes of the detection data can be merged or compressed, for example to obtain a preset format. In addition, by a shift operation and/or a combination rule, a first step of a detection of undesired data traffic in the data network can also already be performed. Thus, it can for example be examined if two predetermined bits in the detection data have a predetermined logical combination (e.g. both set or both deleted). Then, this can be represented by a single bit, which can become a constituent of the input data instead of the original bits.

The invention also provides a monitoring device or switch device for a data network of a motor vehicle, wherein the switch device comprises a network processor and an associative memory and a computing unit, which are configured to perform an aspect of the method according to the invention.

The associative memory can be a CAM, in particular a TCAM, in the described manner. The associative memory can be integrated in the network processor or be provided in a separate memory element. As the network processor, the network processor type known for switch devices can be provided, which can be expanded by the described method steps. As the computing unit for the described processing of the analysis data, a so-called CPU (central processing unit) or a microcontroller can be provided or generally a microprocessor, wherein the computing unit can be coupled to the network processor and/or the associative memory via a respective data interface. The network processor and the computing unit can each be a data processing device or a processor device, which each comprise at least one microprocessor and/or at least one microcontroller and/or at least one FPGA (field programmable gate array) and/or at least one DSP (digital signal processor). The computing unit can be configured freely programmable. Furthermore, a program code can be provided, which is configured to perform method steps of an aspect of the method according to the invention upon execution. The program code can be stored in at least one data memory, to which the computing unit and/or the network processor can be coupled.

The invention also provides a motor vehicle with a data network, in which multiple network branches are interconnected via an aspect of the monitoring device according to the invention. The motor vehicle according to the invention is preferably configured as an automobile, in particular as a passenger car or truck, or as a passenger bus or motorcycle.

The invention also includes the combinations of the features of the described aspects. Thus, the invention also includes realizations, which each comprise a combination of the features of multiple of the described aspects if the aspects were not described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic example of the motor vehicle according to the invention;

FIG. 2 is an outline for illustrating a TCAM, which transmits hit signals to counters, according to an example; and

FIG. 3 is a schematic representation of a readout memory, via which the TCAM can be coupled to a microprocessor, according to an example.

### DETAILED DESCRIPTION

Reference will now be made in detail to the preferred embodiments, examples of which are illustrated in the accompanying drawings, wherein like reference numerals refer to like elements throughout.

The embodiments explained in the following are preferred embodiments of the invention. In the embodiments, the described components of the embodiments each represent individual features of the invention to be considered independently of each other, which also each develop the invention independently of each other. Therefore, the disclosure also is to include other combinations of the features of the embodiments than the illustrated ones. Furthermore, the described embodiments can also be supplemented by further ones of the already described features of the invention.

In the figures, identical reference characters each denote functionally identical elements.

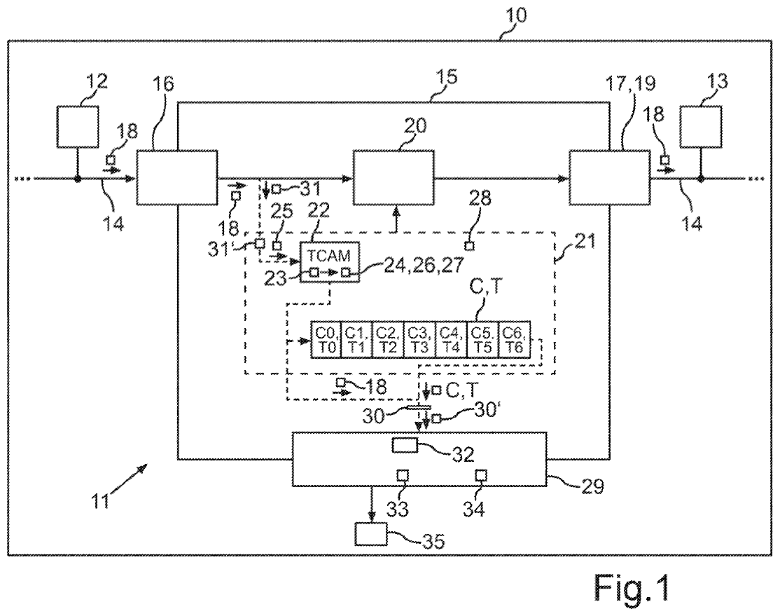

FIG. 1 shows a motor vehicle 10, which can be an automobile, for example a passenger car or truck. In the motor vehicle 10, a data network 11 can be provided, which can for example be an Ethernet network. Control devices 12, 13 for data communication or data exchange can be coupled to each other via the data network 11. In order to interconnect multiple network branches 14 of the data network 11 to each other, a switch device 15 can be provided. Therein, a respective network cable of each network branch 14 can be connected to a respective port 16, 17 of the switch device 15 in a manner known per se. FIG. 1 exemplarily shows how the control device 12 can transmit a data packet 18 to the control device 13. Herein, the switch device 15 can receive the data packet 18 at the port 16, to which the network branch 14 of the control device 12 is connected, and select that port 17, to which the network branch 14 of the control device 13 is connected, from the multiple ports of the switch device 15 (possible further ports are not illustrated), such that the data packet 18 can be forwarded in this network branch 14 and in particular only in this network branch 14. Generally, the data packet 18 can be forwarded by the switch device 15 in particular exclusively to those network branches or that network branch, in which a control device 13 is located, to which the data packet 18 is addressed in a manner known per se, for example via a so-called IP address and/or MAC address.

In order to forward the received data packet 18 to the correct port 17, thus a target port 19, in the switch device 15, a switch circuit 20 (also referred to as switch engine), which can be configured in a manner known per se, can be provided in the switch device 15. The switch circuit 20 can be controlled by a network processor 21. For ascertaining, which target port 19 is to be adjusted for the received data packet 18 in the switch circuit 20, an associative memory 22 can be provided, in particular a TCAM. In the associative memory 22, output data 24 can be associated with a respective possible data pattern 23. From the data packet 18, the data or the data content thereof can for example be read out by the network processor 21 in preset selection positions of the received data packet 18 and be merged to input data 25, which can be passed to the associative memory 22. If the input data 25 includes one of the data patterns 23, thus, the associative memory 22 can output the corresponding output data 24 as target port data 26. Based on the target port data 26, the network processor 21 can for example adjust or select the corresponding target port 19 in the switch circuit 20.

The associative memory can be integrated in the network processor or be different from it. It can be provided that the associative memory 22 is connected to the switch circuit 20 such that the target port data 26 can be evaluated by the switch circuit 20 in direct manner, that is without the network processor 21, for selecting the target port 19.

In the motor vehicle 10, an IDS (intrusion detection system against software errors and/or malware) can also be realized by the switch device 15, that is, it can be recognized if one of the control devices 12, 13 (here, only two control devices are exemplarily illustrated) in the data network 11 is manipulated or affected by a data virus and/or if an unauthorized device is connected to the data network 11 and transmits at least one data packet via the switch device 15.

Hereto, the associative memory 22 can also be used in the switch device 15 without having to comprise an additional functionality.

Hereto, the network processor 21 can keep available at least one position dataset 28, in which monitoring positions can respectively be indicated, which can indicate bits or at least one byte in the received data packet 18, bit positions or byte positions, in which the data or the data content of the received data packet 18 is to be read out. This results in the read-out detection data 31. This detection data 31 can be used to generate input data 25 for monitoring the data network 11. Previously, at least one operation 31′ can be applied to the detection data 31 to form input data 25 for the associative memory 22, but the detection data 31 can also be immediately provided as the input data 25. The input data 25 can be fed into the associative memory 22 to be examined for at least one data pattern 23. If one of the data patterns 23 applies, thus, corresponding output data 24 is output by the associative memory 22. However, this output data 24 is then the hit data 27 of the hit signal 27′, which can each be associated with a corresponding data pattern 23 and which represents a hit signal.

Whenever input data 25 for monitoring the data network triggers a hit signal in the associative memory 22, a respective tuple CT of a counter C and a timestamp T can be updated. For a respective hit signal or a combination thereof, a tuple CT can respectively be provided, which is exemplarily illustrated by seven counters C0 to C6 and associated memories for timestamps T0 to T6 in FIG. 1, wherein the number is here exemplarily chosen. By a microprocessor 29, for the individual tuples CT, thus, the respective combination of counter C and timestamp T, there can be read out from a readout memory 30 the respective value of the counter C and the timestamp T as well as at least one part of that data packet 18 also stored in the readout memory 30, which has provided or caused the last increment of the counter C at the timestamp or point of time of the timestamp T for the trigger signal or hit signal. Hereto, the respectively last data packet 18 of the corresponding tuple CT can also be stored in the readout memory 30.

By the microprocessor 29, it can then be examined by a comparison routine 32 whether a number of hit signals, as it is stored in the respective counter C0 to C6 for the respective data pattern 23, and corresponding transmission schedule data 33 for the associated timestamp T0 to T6, which describes the intended data traffic or data traffic programmed for the control devices 12, 13 (in the non-manipulated state of the data network 11), satisfies a coincidence criterion 34. When the coincidence criterion 34 is not satisfied, thus, when a deviation between the analysis data 30′ from the readout memory 30 and the transmission schedule data 33 arises, thus, a defense routine 35 can be initiated or started by the microprocessor 29. For example, a functional extent of the motor vehicle can be restricted and/or a signal can be emitted to a user of the motor vehicle to inform him that the motor vehicle 10 has to be examined in a garage.

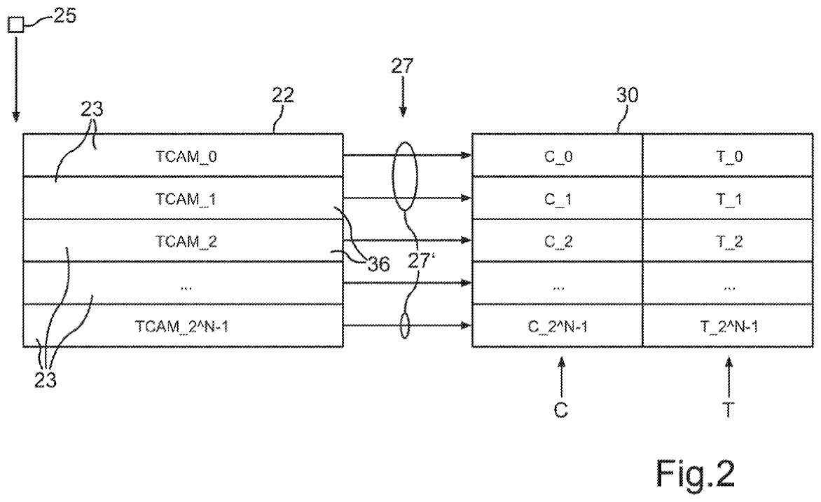

Ag. 2 illustrates how data patterns 23 can be provided as respective entries TCAM_0 to TCAM_2\hat{ }N−1 in the associative memory 22, wherein 2\hat{ }N−1 means that a power of 2 is the number of the overall provided entries. For example, N can be an integer in the range from 0 to 10. If the input data 25 is filtered by the associative memory 22, thus, a coincidence of one of the data patterns 23 with the input data 25 can occur, whereupon the associated hit signal 27′ is generated as the hit data 27. One of the counters C can be associated with each data pattern 23, which is incremented by the respective hit signal 27′, such that the counter reading or counter value C_0 to C_2\hat{ }N−1 is incremented. In addition, for the last received data packet 18, which has lastly triggered the hit signal 27′, the associated timestamp T of reception or of the hit signal 27′ can be stored as a time value T_0 to 2\hat{ }N−1 1. FIG. 2 shows that data patterns 23 of two entries 36 can also be (exemplarily) evaluated by the same counter C as the counter value C_1. Hereby, a manipulation distributed to multiple data patterns 23 of a manipulated data traffic in the data network 11 can also be recognized.

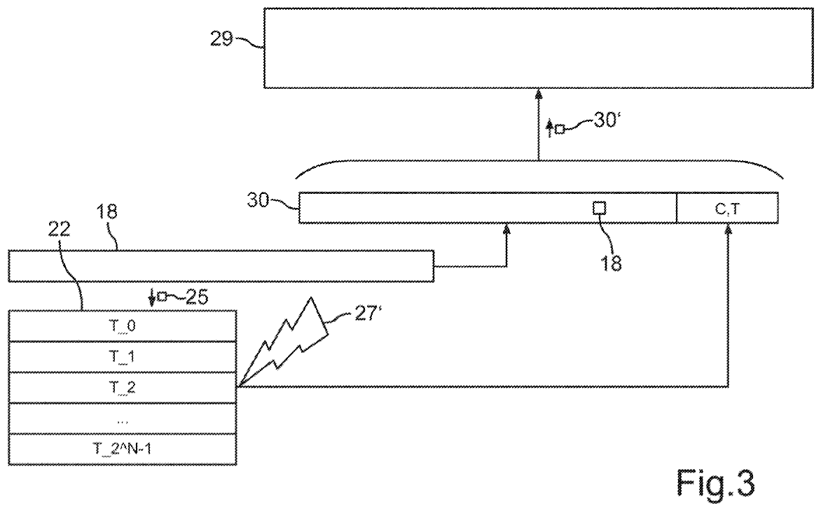

FIG. 3 illustrates how only to the lastly triggered hit signal 27′ from the 25 associative memory 22 the associated data packet 18 and the counter value of the counter C and a timestamp T can be stored in a readout memory 30, which can then be read out as analysis data 30′ by the microprocessor 29. Hereby, only a single readout memory 30 is required for an entry of analysis data 30′, the microprocessor 29 can then serially read out the then updated 30 content of the analysis data 30′ upon each hit signal 27′.

In order to analyze the data traffic, it can be advantageous to have time designations and/or a statistic evaluation to recognize a deviation from a transmission scheme of the control devices of the motor vehicle 10. Such a deviation is an indication of a possible manipulation or attack relating to the motor vehicle 10 and/or the data network 11 thereof. VVith the shown approach, the efficiency of the detection can be increased in that additional data patterns 23 for generating hit signals 27′ relating to possible deviations from the transmission scheme of the control devices 12, 12 are recognized in an associative memory 22. Therein, the main idea is in expanding the present associative memories 22 of a switch device 15 without herein having to newly construct or develop the associative memory 22 itself. Hereto, an associative memory, in particular a TCAM filter, is combined with at least one counter and an associated register for time stamps. This means that a hardware based on TCAM is used not only for detecting or selecting target ports, but the hardware based on TCAM can also be used for generating statistic data relating to the data traffic. If a TCAM filter rule generates a hit, thus a data pattern is recognized and the associated hit signal is generated, the counter value of the associated counter can be incremented and the timestamp of this event can be stored in the associated register of the timestamp. The tuple of counter value and timestamp can be read out by a microprocessor as a computing node, for which a so-called atomic access (exclusive access or access within a clock cycle of the computer) is effected. As an expansion, it can also be provided for the filter rule that the data packet itself, thus, for example an Ethernet frame, is also provided or transferred to the microprocessor as a part of the analysis data, thus together with the tuple of counter value and timestamp. The data pattern 23, which has resulted in the detection, and/or the indication, which counter value is associated or combined with which hit signal, can also be provided as a part of the analysis data.

By the possibility of being able to set or control data patterns or general filter rules for a TCAM, the data patterns can also be set in optimized or adapted manner for a special motor vehicle such that the transmission scheme to be expected for a non-manipulated data network 11 can be taken into account. In that the data packet and the counter value and the time stamp are transferred to a microprocessor via the readout memory, the subsequent analysis or examination for a possible manipulation of the data network can be effected without herein the transfer speed of the data network having to be complied with, thus, the data packet leaving again the switch device within a predetermined maximally admissible latency time. Herein, the accuracy of the analysis can nevertheless be maintained by the timestamps since the point of time of the procedure remains known.

Thus, an aspect of the invention can be implemented in that a set of counters and registers for timestamps is provided, which represents a low additional effort in a switch device. If a TCAM filter rule triggers a hit signal, thus, a data pattern 23 is recognized in the input data 25, in case that multiple data patterns apply, a prioritization of the data patterns can result in the fact that only one hit signal 27′ results in increase of the respective counter value. In the described manner, a counter can also be associated with multiple different filter rules or hit signals 27′. With the microprocessor, data analysis software can be run, wherein reading out a tuple of counter value and timestamp can be effected by a so-called atomic access (access within a clock cycle) or by a shadow buffer. Hereby, an accidental deviation of the cohesiveness of counter value and timestamp can be avoided.

The comparison routine can be based on a method of machine learning, for example of an artificial neural network or a deep learning method, whereby it can also be compensated for that control devices can change their transmission scheme depending on situation.

Overall, the examples show how information for an IDS can be provided by a TCAM and statistic counters in a switch device.

Thus, in summary, the invention in particular relates to the following aspects:
1. A method for monitoring data traffic between control devices (12, 13) of a motor vehicle (10), wherein the control devices (12, 13) are connected via a data network (11), which comprises a switch device (15), in which physical ports (16, 17) for receiving and for transmitting data packets (18) are interconnected via a switch circuit (20), and in the method, target port data (26) is associated with a respective data packet (18), which is received via one of the ports (16, 17), by a network processor (21) by an associative memory (22), and at least one of the ports (16, 17) is selected as a respective target port (19) depending on the target port data (26), and the received data packet (18) is passed to the at least one target port (19) by the switch circuit (20),
characterized in that
at least one predetermined data pattern (23) of a packet type to be monitored and/or detected and/or data content to be detected is stored in the associative memory (22) such that in response to input data (25), if the input data (25) contains the respective data pattern (23), an associated hit signal (27) is generated by the associative memory (22), and
the network processor (21) reads out detection data (31) from the received data packet (18) in predetermined monitoring positions of the data packet (18) and forms input data (25) for the associative memory (22) from the detection data (31) and examines if a hit signal (27) results by inputting the input data (25) into the associative memory (22), and
at least one counter (C) is provided, in which it is indicated by a respective counter value how often a hit signal (27) was generated to at least one predetermined data pattern (23),
and the respective counter value and the respectively last data packet (18), by which the counter value was lastly increased, are provided as analysis data (30′) in a readout memory (30), and
a microprocessor (29) reads out the respectively current analysis data (30′) via a data interface and recognizes based on transmission schedule data (33), which describes an intended transmission scheme of the control devices (12, 13), by a predetermined comparison routine (32) that the analysis data (30′) deviate from the transmission scheme, and initiates a predetermined defense routine (35) in this case.
2. The method according to aspect 1, wherein a timestamp (T) of the respectively last increase of the counter value is also kept stored for each of the at least one counter (C) in addition to the counter value and provided as a part of the analysis data (30′) in the readout memory (30).
3. The method according to any one of the preceding aspects, wherein at least one counter (C) counts the hit signals (27) for at least two data patterns.
4. The method according to any one of the preceding aspects, wherein the respective counter value of the at least one counter (C) is reset by the network processor (21) and/or the microprocessor (29) if a predetermined reset condition is satisfied.
5. The method according to any one of the preceding aspects, wherein multiple datasets are provided for different monitoring positions, and
a packet characteristic of the respective data packet (18) is ascertained by the network processor (21) based on the data packet (18), and
one of the datasets is selected depending on the packet characteristic and the detection data (31) is read out in the monitoring positions, which are indicated by the selected dataset (28).
6. The method according to aspect 5, wherein the packet characteristic indicates a protocol type and/or a packet type and/or a data content.
7. The method according to any one of the preceding aspects, wherein the monitoring positions describe disjunct data fields of the data packet (18).
8. The method according to any one of the preceding aspects, wherein forming the input data (25) includes that the detection data (31) is rearranged by a shift operation and/or is combined by at least one combination rule.
9. A switch device (15) for a data network (11) of a motor vehicle (10), wherein the switch device (15) comprises a network processor (21) and an associative memory (22) and a microprocessor (29), which together are configured to perform a method according to any one of the preceding aspects.
10. A motor vehicle (10) with a data network (11), in which multiple network branches are interconnected via a switch device (15) according to aspect 9.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for monitoring data traffic between control devices of a motor vehicle, the control devices being connected via a data network, which includes a switch device, in which physical ports for receiving and for transmitting data packets are interconnected via a switch circuit, the method comprising:
associating target port data with a respective data packet, which is received via one of the ports, by a network processor by an associative memory, at least one of the ports being selected as a respective target port depending on the target port data, and the received data packet being transmitted to at least one target port by the switch circuit, the associating including:
storing, in the associative memory, at least one predetermined data pattern of a packet type to be monitored and/or detected and/or data content to be detected;
reading, by the network processor, detection data from the received data packet in predetermined monitoring positions of the data packet and forming input data for the associative memory from the detection data;
generating, by the associative memory, an associated hit signal in response to input data when the input data includes the respective data pattern; and
determining, by the network processor, whether the hit signal results by inputting the input data into the associative memory; and
determining, by a microprocessor, whether to initiate a predetermined defense routine, the determining including:
indicating, by at least one counter, a respective counter value corresponding to how often the hit signal was generated based on at least one predetermined data pattern;
storing, in a readout memory, analysis data including the respective last data packet, the counter value, and a timestamp of the respectively last increase of the counter value for each of the at least one counter (C);
reading, by the microprocessor, the respectively current analysis data via a data interface;
determining, by the microprocessor, based on transmission schedule data, which describes an intended transmission scheme of the control devices, by a predetermined comparison routine whether the analysis data deviates from the transmission scheme; and
initiating, by the microprocessor, the predetermined defense routine when the analysis data deviates from the transmission scheme.

11. The method according to claim 10, wherein at least one counter (C) counts the hit signals for at least two data patterns.

12. The method according to claim 10, wherein the respective counter value of the at least one counter (C) is reset by the network processor and/or the microprocessor when a predetermined reset condition is satisfied.

13. The method according to claim 11, wherein the respective counter value of the at least one counter (C) is reset by the network processor and/or the microprocessor when a predetermined reset condition is satisfied.

14. The method according to claim 10, wherein multiple datasets for different monitoring positions are provided and a packet characteristic of the respective data packet is ascertained by the network processor based on the data packet, and one of the datasets is selected depending on the packet characteristic and the detection data is read out in the monitoring positions, which are indicated by the selected dataset.

15. The method according to claim 11, wherein multiple datasets for different monitoring positions are provided and a packet characteristic of the respective data packet is ascertained by the network processor based on the data packet, and one of the datasets is selected depending on the packet characteristic and the detection data is read out in the monitoring positions, which are indicated by the selected dataset.

16. The method according to claim 12, wherein multiple datasets for different monitoring positions are provided and a packet characteristic of the respective data packet is ascertained by the network processor based on the data packet, and one of the datasets is selected depending on the packet characteristic and the detection data is read out in the monitoring positions, which are indicated by the selected dataset.

17. The method according to claim 13, wherein multiple datasets for different monitoring positions are provided and a packet characteristic of the respective data packet is ascertained by the network processor based on the data packet, and one of the datasets is selected depending on the packet characteristic and the detection data is read out in the monitoring positions, which are indicated by the selected dataset.

18. The method according to claim 14, wherein the packet characteristic indicates a protocol type and/or a packet type and/or a data content.

19. The method according to claim 10, wherein the monitoring positions describe disjunct data fields of the data packet.

20. The method according to claim 11, wherein the monitoring positions describe disjunct data fields of the data packet.

21. The method according to claim 12, wherein the monitoring positions describe disjunct data fields of the data packet.

22. The method according to claim 14, wherein the monitoring positions describe disjunct data fields of the data packet.

23. The method according to claim 10, wherein forming the input data includes that the detection data is rearranged by a shift operation and/or is combined by at least one combination rule.

24. The method according to claim 11, wherein forming the input data includes that the detection data is rearranged by a shift operation and/or is combined by at least one combination rule.

25. A switch device for a data network of a motor vehicle, the switch device comprising:
an associative memory to store at least one predetermined data pattern of a packet type to be monitored and/or detected and/or data content to be detected and to generate an associated hit signal in response to input data when the input data includes the respective data pattern;
a network processor to associate target port data with a respective data packet, which is received via one of the ports, at least one of the ports being selected as a respective target port depending on the target port data, and the received data packet being transmitted to at least one target port by the switch circuit, including:
reading, by the network processor, detection data from the received data packet in predetermined monitoring positions of the data packet and forming the input data for the associative memory from the detection data; and
determining, by the network processor, whether the hit signal results by inputting the input data into the associative memory; and
a microprocessor to determine whether to initiate a predetermined defense routine based on transmission schedule data, which describes an intended transmission scheme of the control devices, by a predetermined comparison routine and whether analysis data deviates from the transmission scheme, the analysis data including a respective last data packet, a counter value corresponding to how often the hit signal was generated based on at least one predetermined data pattern, and a timestamp of the respectively last increase of the counter value for each of at least one counter (C), the microprocessor to initiate the predetermined defense routine when the analysis data deviates from the transmission scheme.

26. A switch device as in claim 25, wherein at least one counter (C) counts the hit signals for at least two data patterns.

27. The switch device as in claim 25, wherein the respective counter value of the at least one counter (C) is reset by the network processor and/or the microprocessor when a predetermined reset condition is satisfied.

28. A motor vehicle comprising:
a data network, in which multiple network branches are interconnected; and
a switch device to interconnect the multiple network branches, the switch device comprising:
an associative memory to store at least one predetermined data pattern of a packet type to be monitored and/or detected and/or data content to be detected and to generate an associated hit signal in response to input data when the input data includes the respective data pattern;
a network processor to associate target port data with a respective data packet, which is received via one of the ports, at least one of the ports being selected as a respective target port depending on the target port data, and the received data packet being transmitted to at least one target port by the switch circuit, including:
reading, by the network processor, detection data from the received data packet in predetermined monitoring positions of the data packet and forming the input data for the associative memory from the detection data; and
determining, by the network processor, whether the hit signal results by inputting the input data into the associative memory; and
a microprocessor to determine whether to initiate a predetermined defense routine based on transmission schedule data, which describes an intended transmission scheme of the control devices, by a predetermined comparison routine and whether analysis data deviates from the transmission scheme, the analysis data including a respective last data packet, a counter value corresponding to how often the hit signal was generated based on at least one predetermined data pattern, and a timestamp of the respectively last increase of the counter value for each of at least one counter (C), the microprocessor to initiate the predetermined defense routine when the analysis data deviates from the transmission scheme.

29. A motor vehicle as in claim 28, wherein at least one counter (C) counts the hit signals for at least two data patterns.
